(19) United States
(12) Patent Application Publication
(10) Pub. No.: US 2014/0122258 A1
(43) Pub. Date: May 1, 2014

(54) SPONSORED AD-EMBEDDED AUDIO FILES AND METHODS OF PLAYBACK

(71) Applicant: Michael A Sharp, Porter, TX (US)

(72) Inventor: Michael A Sharp, Porter, TX (US)

(21) Appl. No.: 14/063,878

(22) Filed: Oct. 25, 2013

Related U.S. Application Data
(60) Provisional application No. 61/718,668, filed on Oct. 25, 2012.
(60) Provisional application No. 61/798,258, filed on Mar. 15, 2013.

(51) Int. Cl. G06Q 30/02

(52) U.S. Cl. CPC G06Q 30/0277
USPC 705/14.73

(57) ABSTRACT

This disclosure is related to methods and systems involving combination of sponsored advertisements with multimedia files and methods of playback. In one representative embodiment, a method of combining advertising content with multimedia content available for download by a user comprises receiving a request to download a multimedia file from a multimedia content server available through a multimedia provider service, the request originating from a client media player. The method further comprises combining the multimedia file with advertisements provided by sponsors to create a combined multimedia and advertisement file, transmitting the combined multimedia and advertisement file to the client media player, saving the combined multimedia and advertisement file for later playback, and playing the advertisements when the combined multimedia and advertisement file is played back. The advertisements can be configured to play a predetermined number of times and then cease playing after the combined multimedia and advertisement file has been played back the predetermined number of times.

### CROSS REFERENCE TO RELATED APPLICATION

This application claims the benefit of U.S. Provisional Application No. 61/718,668, filed Oct. 25, 2012, which is herein incorporated by reference in its entirety. This application also claims the benefit of U.S. Provisional Application No. 61/798,258 filed Mar. 15, 2013, which is also herein incorporated by reference in its entirety.

### FIELD

This disclosure is related to methods and systems involving combination of sponsored advertisements with multimedia files and methods of playback.

### BACKGROUND

Traditionally, multimedia files are downloaded from the Internet for a fee from online multimedia distributor services such as iTunes. Users then “own” the downloaded copy of the multimedia file, which can be played back by multimedia players on any of various electronic devices, including mobile phones, personal computers, laptops, tablets, portable music players, etc. However, users frequently do not want to pay or cannot afford to pay to download multimedia content and, in some cases, resort to illegal downloading of copyrighted material. Furthermore, once the user has paid to download the multimedia file, the ability of commercial interests to reach the user through, e.g., advertising content, is greatly diminished because the user now owns the downloaded copy of the multimedia file. Accordingly, improvements to multimedia files and methods of playback are desirable.

### SUMMARY

The methods and systems disclosed herein pertain to combining advertising content with multimedia content downloaded by a user over a network. In one representative embodiment, a method of combining advertising content with multimedia content available for download by a user comprises receiving a request to download a multimedia file from a multimedia content server available through a multimedia provider service, the request originating from a client media player. The method further comprises combining the multimedia file with one or more advertisements provided by one or more sponsors to create a combined multimedia and advertisement file, transmitting the combined multimedia and advertisement file to the client media player, saving the combined multimedia and advertisement file for later playback, and playing the one or more advertisements when the combined multimedia and advertisement file is played back on the media player. The one or more advertisements can be configured to play a predetermined number of times and then cease playing after the combined multimedia and advertisement file has been played back the predetermined number of times. Thus, if a user cannot afford to purchase multimedia files, instead of being forced to pirate the multimedia files, they can elect to download the multimedia file combined with an advertisement paid for by one or more sponsors that plays one or more times. The user can thereby eventually enjoy ownership of the multimedia file without advertisements.

In another representative embodiment, a system for combining advertising content with multimedia content available for download by a user comprises a media player configured to play multimedia files and a multimedia provider service in communication with the media player over a network. The media provider service can include a multimedia content server having a database containing multimedia files and an advertising content server containing advertisements. The multimedia provider service can be configured to receive a request from the media player to download a multimedia file, combine the requested multimedia file with one or more advertisements, and then transmit the combined multimedia and advertisement file to the media player. The one or more advertisements can be configured to play a predetermined number of times when the combined multimedia and advertisement file is played back on the media player and then cease playing after the combined multimedia and advertisement file has been played back the predetermined number of times.

In another representative embodiment, a method of combining advertising content with media content made available for download on-demand by a user comprises receiving a first media file from a first party containing non-advertising content. The method further comprises receiving a second media file from a second party containing advertising content, receiving a request to identify media content being concurrently experienced by a user containing data associated with the media content, and identifying the media content as the first media file based at least in part on the data provided in the request. The method further comprises combining the first media file with the second media file to create a third media file, and transmitting the third media file to at least one device designated by the user where the third media file is saved for later playback.

In another representative embodiment, a system for on-demand identification and retrieval of media content comprises a media player configured to play media content received from a remote source and a media download service. The media download service is in communication with the media player, and is configured to receive a request to identify media content from the media player where the media content is being concurrently received by the media player from the remote source. The media download service is also configured to identify the media content based at least in part upon information provided to the media download service in the identification request, and transmit the identified media content to the media player.

In another representative embodiment, the media download service can be further configured to combine the identified media content with an advertisement before transmission of the media content to the media player.

In another representative embodiment, the advertisement can be provided by a first party and the media content can be provided by a second party, and the first party can be charged a fee for combining of the advertisement with the media file before transmission to the media player.

In another representative embodiment, the media player comprises at least one of an automobile stereo, a radio, a mobile phone, a portable music player, a computer, or a tablet.

In another representative embodiment, the request to identify media comprises audio data sampled from the media content currently being received by the media device from the remote source.

In another representative embodiment, the request to identify media comprises textual data associated with the media content being currently received by the media device from the remote source.

In another representative embodiment, the media content can be a song and the remote source can be a radio station.

In another representative embodiment, the media player and the media download service can be in communication over a wireless network.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic representation of a computing environment in which certain embodiments of the systems and methods disclosed herein can be implemented.

FIG. 2 is a schematic representation of a computer network.

FIG. 3 is a front view of a media player.

FIG. 4 is a schematic representation of a system for identifying and retrieving media content on demand.

FIG. 5 is a front view of the media player of FIG. 2 downloading a song.

FIG. 6 is a front view of the media player of FIG. 4 after finishing downloading the song.

FIG. 7 is a block diagram illustrating how a computer network can be used to identify and retrieve media content on demand.

FIG. 8 is a block diagram illustrating another method by which a computer network can be used to identify and retrieve media content on demand.

FIG. 9 is a front view of another embodiment of a media player.

FIG. 10 is a front view of the media player of FIG. 9 displaying a multimedia file library.

FIG. 11 is a front view of the media player of FIG. 9 displaying a download quality menu.

FIG. 12 is a schematic representation of a system for combining a multimedia file with an advertisement and delivering the combined multimedia file and advertisement to a client user.

FIG. 13 is a block diagram illustrating a method by which a computer network can be used to combine a multimedia file with an advertisement and deliver the combined multimedia file and advertisement to a client user.

### DETAILED DESCRIPTION

### General Considerations

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “provide” to describe the disclosed methods. These terms are high-level abstractions of the actual operations that are performed. The actual operations that correspond to these terms may vary depending on the particular implementation and are readily discernible by one of ordinary skill in the art.

As used herein, the terms “a”, “an” and “at least one” encompass one or more of the specified element. That is, if two of a particular element are present, one of these elements is also present and thus “an” element is present. The terms “a plurality of” and “plural” mean two or more of the specified element. As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.”

### Illustrative Operating Environment

Various systems for providing supplemental data to users during file transfer actions are described below. In some embodiments, these systems—including the transfer of files and the associated supplemental data—may be implemented or performed, at least in part, by software stored on one or more tangible computer-readable media (e.g., one or more optical media discs, volatile memory or storage components (such as DRAM or SRAM), or nonvolatile memory or storage components (such as hard drives)) and executed on one or more computing systems. Some basic background information relating to computing systems capable of transferring files as discussed above are provided.

The computing systems can include one or more central processing units (CPUs) and a memory, such as random access memory (RAM) for temporary storage of information and/or a read only memory (ROM) for permanent storage of information, and a mass storage device, such as a hard drive, diskette, or optical media storage device. Typically, the modules of the computing system are connected to the computer using a standards-based bus system, such as, for example, Peripheral Component Interconnect (PCI), Microchannel, SCSI, Industrial Standard Architecture (ISA) and Extended ISA (EISA) architectures. The computing system may also include one or more commonly available input/output (I/O) devices and interfaces, such as a keyboard, a mouse, and/or a touchpad. In one embodiment, the I/O devices and interfaces include one or more display devices, such as a monitor, that allows the visual presentation of data to a user. More particularly, a display device provides for the presentation of Graphical User Interfaces (GUIs), application software data, and multimedia presentations, for example. The computing system may also provide a communications interface to various external devices.

Such software can be executed on a single computer or on a networked computer (e.g., via the Internet, a wide-area network, a local-area network, a client-server network, or other such network). The systems and methods disclosed herein can also be performed using cloud computing, a form of Internet-based computing, whereby shared resources, software and information are provided to computers and other devices on-demand. The software embodiments disclosed herein can be described in the general context of computer-executable instructions, such as those included in program modules, which can be executed in a computing environment on a target real or virtual processor. The computing system may run on a variety of computing devices, such as, for example, a server, a Windows server, a Structure Query Language server, a Unix server, a personal computer, a mainframe computer, a laptop computer, a cell phone, a personal digital assistant, a kiosk, a multimedia player, and so forth. The computing system is generally controlled and coordinated by operating system software. Conventional operating systems control and schedule computer processes for execution, perform memory management, provide file system, networking, and I/O services, and provide a user interface, such as a graphical user interface, among other things.

Furthermore, any of the software embodiments (comprising, for example, computer-executable instructions for causing a computer to perform any of the disclosed methods) can be transmitted, received, or accessed through a suitable communication means. Similarly, any data structure, data file, intermediate result, or final result created or modified using any of the disclosed methods can be transmitted, received, or accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means now known or unknown. Moreover, any data structure, data file, intermediate result, or final result produced by any of the disclosed methods can be displayed to a user using a suitable display device (e.g., a computer monitor or display). Such displaying can be performed as part of a computer-implemented method of performing any of the disclosed methods. As the techniques of the disclosed technology may be implemented using a programmable computer system executing software instructions, the components and operation of a computer system on which various implementations of the disclosed technology may be employed is described.

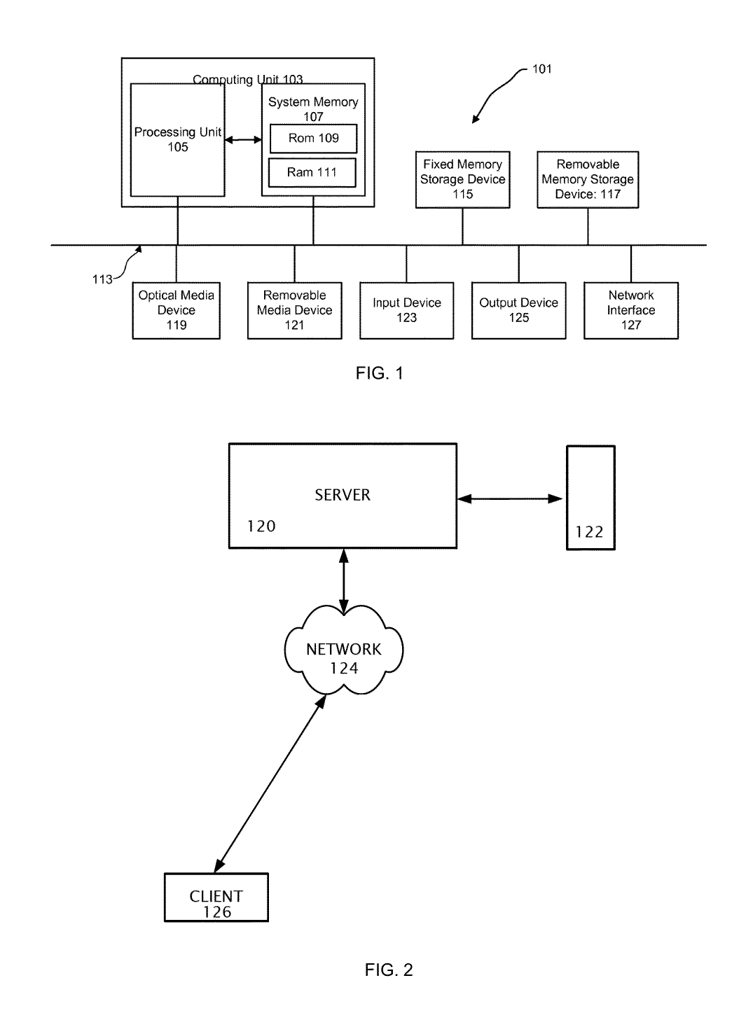

Accordingly, FIG. 1 shows an illustrative computing device 101. As seen in this figure, the computing device 101 includes a computing unit 103 having a processing unit 105 and a system memory 107. The processing unit 105 may be any type of programmable electronic device for executing software instructions, but will conventionally be a microprocessor. The system memory 107 may include a read-only memory (“ROM”) 109 and/or a random access memory (“RAM”) 111. As will be appreciated by those of ordinary skill in the art, either or both of the ROM 109 or the RAM 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional devices, such as: a fixed memory storage device 115, for example, a magnetic disk drive; a removable memory storage device 117, for example, a removable solid state disk drive; an optical media device 119, for example, a digital video disk drive; or a removable media device 121, for example, a removable drive. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computing device 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (“USB”) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (“TCP”) and the Internet protocol (“IP”). Also, the interface 127 may employ any suitable connection agent (or combination of agents) for connecting to a network, including, for example, a wireless transceiver, a modem, or an Ethernet connection.

It should be appreciated that the computing device 101 is shown here for illustrative purposes only, and it is not intended to be limiting. Various embodiments of the invention may be implemented using one or more computers that include the components of the computing device 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, a mobile computing device such as a smartphone, tablet, or portable multimedia player, or any combination thereof.

As stated above, various embodiments of the invention may be implemented using a programmable computer system executing software instructions, a computer readable medium having computer-executable software instructions stored thereon, or some combination thereof. Particularly, these software instructions may be stored on one or more computer readable media or devices, such as, for example, the system memory 107, or an optical disk for use in the optical media device 119. As those of ordinary skill in the art will appreciate, software instructions stored in the manner described herein are inherently non-transitory in nature. More specifically, the software instructions are available for execution by the computer system 101, as opposed to being transmitted to the computer system via a carrier wave or some other transitory signal.

FIG. 2 shows a simplified embodiment of an exemplary network that can achieve file transfers as described herein. A server computer 120 can have an associated storage device 122 (internal or external to the server computer). The server computer 120 can be coupled to a network, shown generally at 124, which can comprise, for example, a wide-area network, a local-area network, a client-server network, the Internet, or other such network. One or more client computer (e.g., a user's computing device), such as that shown at 126 can be coupled to the network 124 using a network protocol. When downloading a file from network 124, supplemental data can be delivered at the same time as the file being transferred from network 124 to user computer 126.

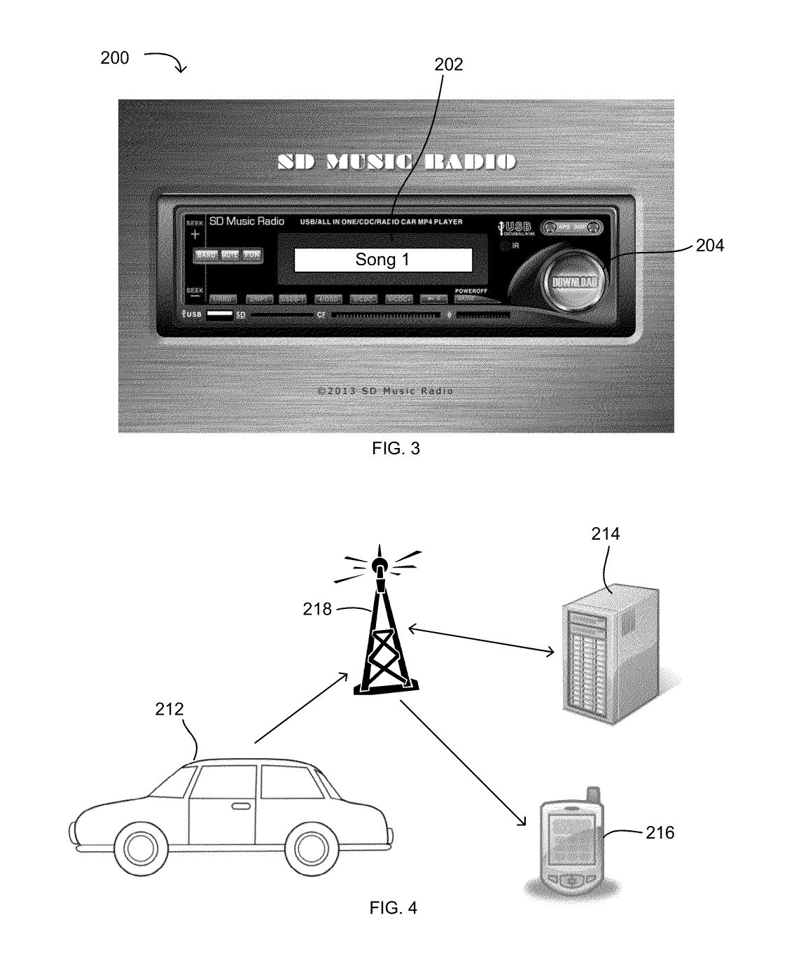

Referring to FIG. 3, there is shown one embodiment of a media player 200 configured as an automobile radio or stereo system. In some embodiments, the media player 200 can comprise a screen 202, a download button 204, and an information button 206, in addition to the functionality found on conventional automobile stereo systems (e.g., tuner, volume, seek, etc.).

Referring to FIGS. 3-4, the media player 200 can be incorporated into an automobile, such as the automobile 212 of FIG. 2. The media player 200 can be in communication with a media download service represented generally at 214. When a user hears a song on the radio that the user wishes to download, the user can press the download button 204 (see, e.g., FIG. 3). The media player can then send a request to the media download service 214 to identify the song currently playing on the radio, and cause the song to be transmitted or downloaded to a designated receiving device 216, as shown in FIG. 4. The designated receiving device 216 can comprise, for example, a portable music player, mobile phone, tablet, computer, local memory on the media player 200, or any combination thereof. The user can specify the designated receiving device(s) before or at the time of downloading the song, and the device can be configured to save the song for playback by the user. In some embodiments, the song can be transmitted over a wireless network 218, such as a cellphone network or a wireless local area network (LAN). In some embodiments, the media player can be configured to interface with analog or digital content broadcast on the radio (e.g., AM radio, FM radio, etc.), content streamed over the Internet (e.g., Pandora® Internet Radio) or content made available by subscription music services (e.g., SiriusXM® satellite radio).

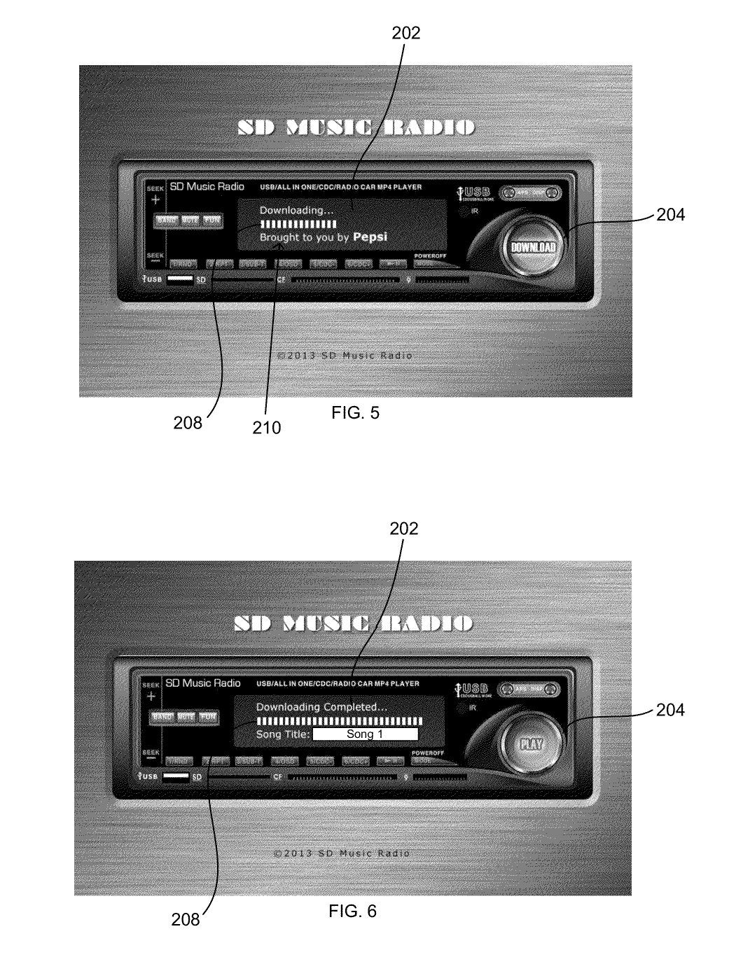

The media download service can include software configured to identify the song currently being played on the radio. In some embodiments, the media download service can identify the song by audio fingerprinting, wherein audio data of the currently playing song is sampled by the media player and transmitted to the media download service. The sampled audio data can be matched with audio files in the database of the media download service to ensure that the correct song is retrieved. The media player can also be configured to transmit the text information (e.g., song title, artist name, etc.) provided over the air and typically displayed on the screens of automobile radio units to the media download service to ensure that the correct song is identified. Once the correct song is identified, the song can be made available for download over the wireless network. In some embodiments, the screen 202 can be configured to display a progress bar 208 so that the user can follow the progress of the download, as shown in FIG. 5.

In some embodiments, an advertisement can be combined with the song file before transmission to the user. In this manner, the user can receive the song file with the advertisement such that when the song file is played by the user, the advertisement is played as well. Each song, or each delivery of a song, can have one or more sponsors. The one or more sponsors can provide the advertisements that are combined with the song file before the song file is delivered to the user. Each time an advertisement is combined with a song and delivered in response to a request by a user, the originating sponsor of the advertisement can be charged a fee. In this manner, the fees charged to sponsors can be provided to publishers of the media content made available to users on the database.

In some embodiments, the advertisements can comprise audio advertisements and can be from about five seconds to about sixty seconds long. The advertisements can be configured to play the first time the song file is played by the user, every time the song is played by the user, or any other suitable number of times. In some embodiments, the length of the advertisement, number of advertisements combined with the song, and the number of times the advertisement plays after receipt of the song by the user can depend upon, for example, the popularity of the song (as measured by, e.g., the number of downloads, position of the song on one or more record charts, etc.), or the fee paid by the sponsor, etc. For example, in some embodiments, an advertisement combined with a song can play the first time that the user listens to the downloaded song and then never play again. In other embodiments, the advertisement can play a specified number of times (e.g., three times, five times, ten times, etc.) or every time the user plays the downloaded song.

In some embodiments, the media content providers can specify the fee to be paid by a sponsor for combining an advertisement with a particular song. In alternative embodiments, the sponsors can bid for the privilege of having their advertisement combined with a song in real time as requests for identification and download are received from users. In other embodiments, sponsors can specify an amount that they will pay for their advertisement to be combined with a song, and providers of media content can specify the amount that they wish to charge, and the media download service can match advertisements and song files for combination in accordance with the price parameters established by the sponsors and providers.

In the embodiment shown in FIG. 5, the screen 202 of the media player can also display textual advertising content 210 while the song file is being downloaded. For example, the textual advertising content can read “Brought to you by PEPSI®.” In some embodiments, the textual advertising content and the advertisement embedded in the song file can originate with the same sponsor, or from different sponsors. In some embodiments, when the user elects to download the song file to local memory on the media player and the file has finished downloading, the download button 204 can be configured to play the downloaded song file when pressed by the user, as shown in FIG. 6. It should be understood that the media player and system disclosed herein can be implemented in any environment and on any device capable of receiving or presenting media content.

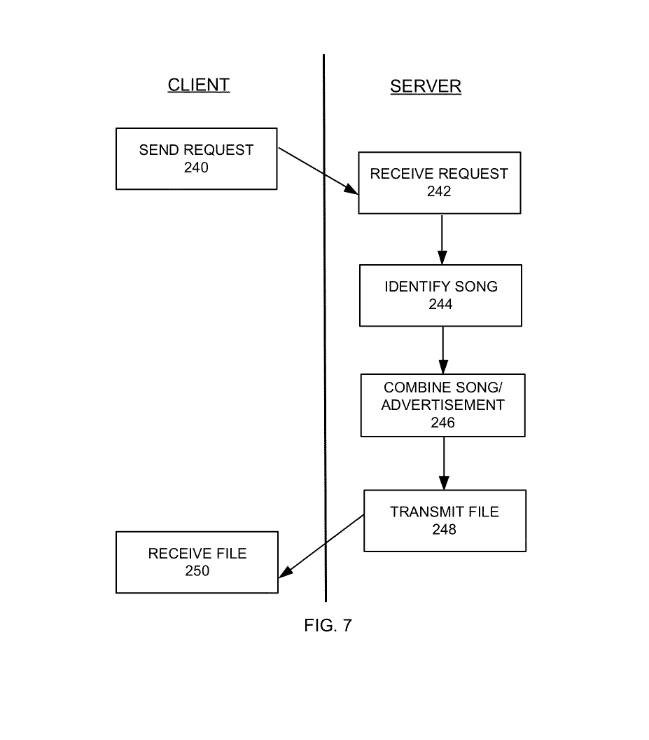

FIG. 7 shows an exemplary manner in which computer-executable instructions for performing any of the disclosed embodiments can be transmitted, accessed, or received using a remote server computer or a remote computing environment, such as the computing device 101. At process block 240, for example, the client media player sends a request to identify and download media content currently being experienced by a user in the user's environment, such as a song playing on the radio, a movie being shown at a movie theater, or a television show playing on a television. The request can contain a data file comprising data, such as audio data, sampled from the media content. Alternatively, the request can contain textual information received by the media player from, for example, a radio station or other broadcast entity, such as the title of a song and/or the name of an artist.

In process block 242, the request is received by the remote server or by respective components of the remote computing environment. In process block 244, the remote server or computing environment uses the data contained in the request to identify the media content currently being experienced by the user. In process block 246, the remote server or remote computing environment combines a media file containing the requested content with one or more advertisements, and transmits the combined media/advertisement file to the user in block 248. The combined media/advertisement file is received (e.g., stored, buffered, and/or executed) by the client media player or another device designated by the user at block 250. In this manner, the user can instantly download, for example, a song heard on the radio over the computer network.

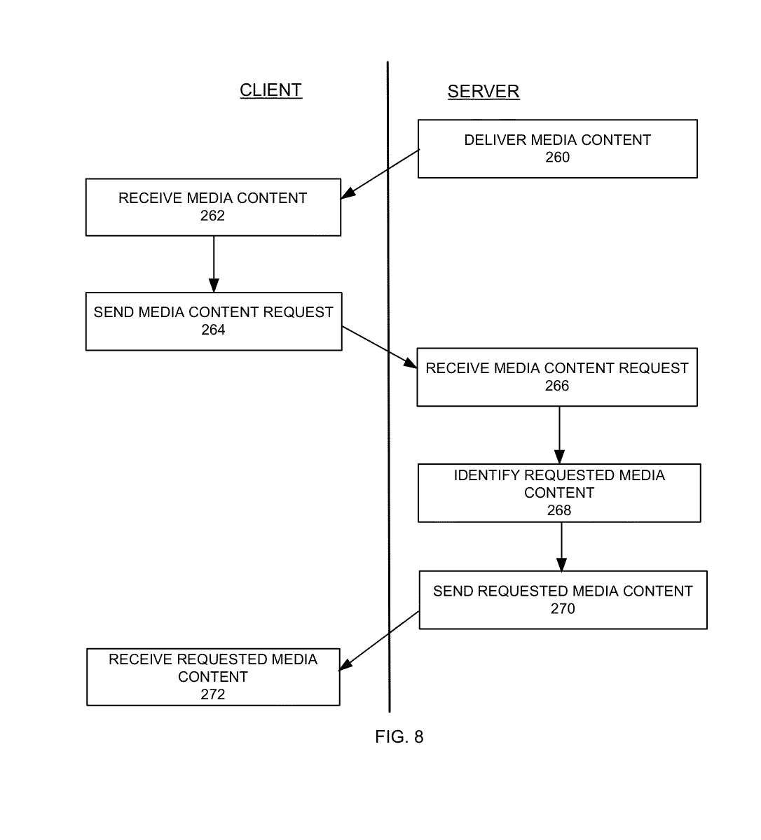

FIG. 8 shows another exemplary manner in which computer-executable instructions for performing any of the disclosed embodiments can be transmitted, accessed, or received using a remote server computer or a remote computing environment. At process block 260, for example, the server delivers media content to the client media player, such as a movie or a television show, over the Internet, which is received by the client media player at process block 262 and experienced by a user. At block 264, the client media player sends a request to identify and download at least a portion of the media content currently being experienced by the user, such as the movie or television show in its entirety, or a song incorporated into the movie or television show. The request to identify the media content is received by the server at block 266, and the server identifies the media content at block 268. The server then transmits or sends the requested media content to the user at block 270, and the requested media content is received by the client media player at block 272.

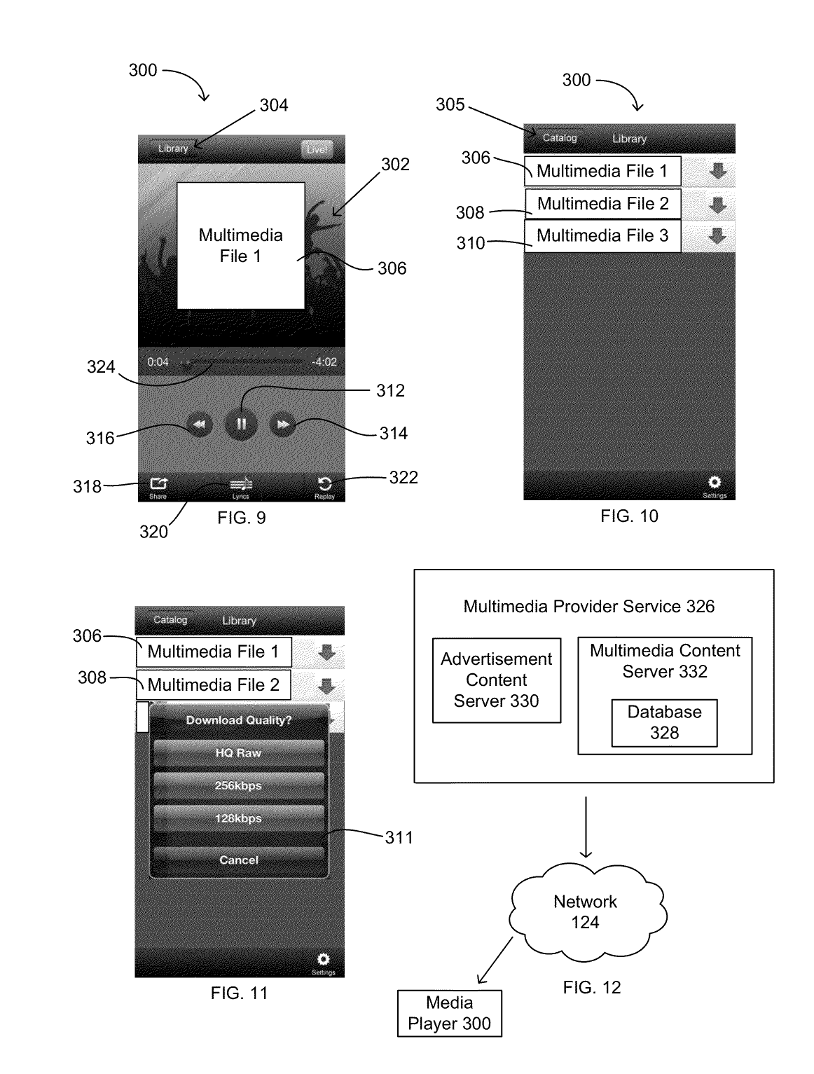

Referring to FIGS. 9-13, there is shown another embodiment of a media player 300 configured as a software application for use on a computing device, such as the computing device 101 described above. The media player 300 can comprise a graphical user interface 302 for displaying content to a user, and a media library 304 including one or more multimedia files, such as first, second, and third multimedia files 306, 308, and 310, respectively (FIG. 10). The multimedia files can include, for example, audio media such as individual songs or whole music albums, podcasts, etc., video media such as movies, or any other suitable type of multimedia file. The multimedia files 306, 308, 310 can be stored locally on memory located in the computing device 101, or stored remotely and accessed by the media player 300 over a network (e.g., the network 124 of FIG. 2).

The media player 300 can further include a play/pause button 312, fast-forward and rewind buttons 314, 316, a share button 318, a lyrics button 320, a replay button 322, and a progress bar 324. The share button 318 can allow a first user to share a downloaded multimedia file with other users, e.g., users that are connected with the first user on a social networking service such as Facebook, Twitter, etc. When the multimedia file being played back is a song, the lyrics button 320 can be configured to display the lyrics of the song in the window 302 of the media player when activated. In some embodiments, the media player can be configured as an application available from internet websites such as Apple, Google, Facebook, etc., and from other websites including websites with lower traffic. The multimedia player can be configured for download to any computing device, including but not limited to personal computers, laptops, and mobile devices, such as tablets, smart phones, etc.

In some embodiments, each multimedia file, or each download of a multimedia file, can have one or more sponsors, as described above with respect to the embodiment of FIGS. 2-7. The one or more sponsors can provide advertisements that are combined with the multimedia files before the multimedia files are delivered to the user, as further described below. Each time an advertisement is combined with a multimedia file and delivered in response to a download request by a user, the originating sponsor of the advertisement can be charged a fee. In this manner, the fees charged to sponsors can be provided to publishers of the multimedia file, and the multimedia file can be provided to the user free of charge. In alternative embodiments, the media player can be configured to allow users to download multimedia files free of charge and without associated advertisements.

Referring to FIG. 12, the media player 300 can be in communication, e.g., over network 124, with a multimedia provider service 326. The multimedia provider service 326 can have a multimedia content server 332 having a database 328 of multimedia files, such as music files, video files, etc., available for download to the media player 300 by a user for a fee. The database 328 can be accessible remotely from the media player with the catalog button 305 (FIG. 10), and can display the multimedia files available on the database 328 on the graphical user interface 302 of the media player. The multimedia provider service 326 can also have an advertisement content server 330 having advertisements provided by one or more sponsors. The user can search the database 328 for a multimedia file that they would like to download, and then the user can either download the multimedia file for a fee (e.g., $0.99, $1.29, etc.) or the user can elect to download the multimedia file for free with one or more advertisements combined or otherwise associated with the multimedia file. As shown in FIG. 11, the media player can include a download quality prompt window 320 allowing the user to select the quality of the multimedia file from among, e.g., high quality/raw data, 256 kilobytes per second, or 128 kilobytes per second. In some embodiments, the media player can also be configured to allow voice-activated downloads. For example, speaking a phrase such as “download song” can initiate a download from the multimedia provider service 326.

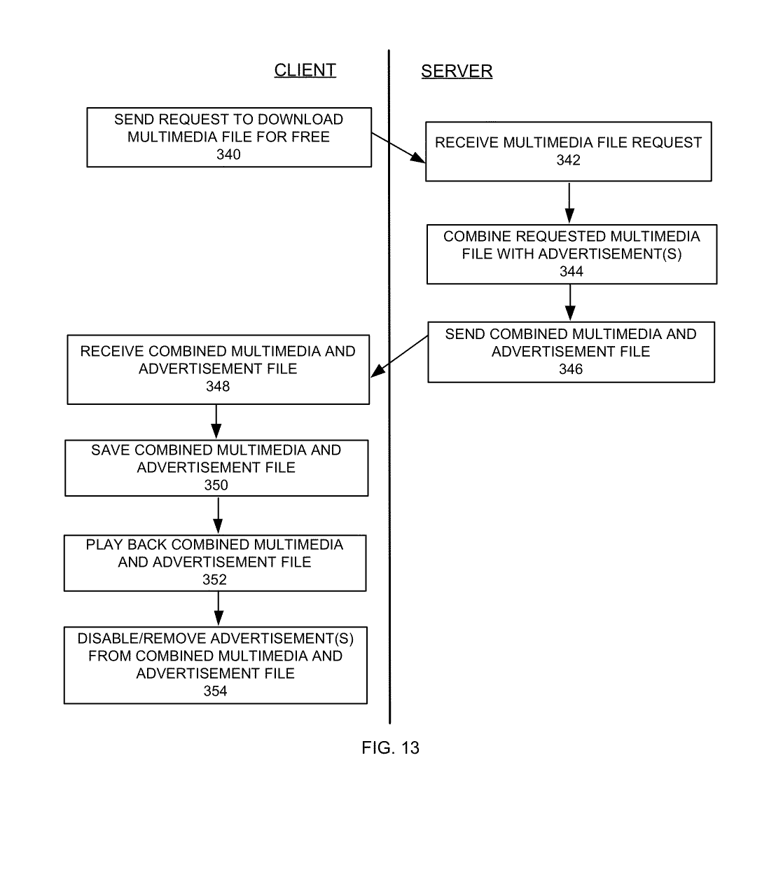

As stated above, a user can download the multimedia file for a fee or elect to download the multimedia file for free combined with one or more advertisements. If the user elects to download a multimedia file for free with an advertisement, the media player 300 sends a request to download the multimedia file for free, as shown at process block 340 of FIG. 13. The multimedia provider service 326 receives the download request at process block 342, and combines the requested multimedia file with one or more advertisements from the advertisement content server 330 at process block 344 to create a combined multimedia and advertisement file. The multimedia provider service 326 can then send the combined multimedia and advertisement file to the media player 300 over the network 124, and the media player 300 can receive the combined multimedia and advertisement file at process block 348. The media player can then save the combined multimedia and advertisement file at process block 350, and play back the combined multimedia and advertisement file at process block 352. After the one or more advertisements of the combined multimedia and advertisement file have been played back a predetermined number of times, the one or more advertisements can be disabled or removed from the combined multimedia and advertisement file at process block 354. As used herein the term “disable” in the context of the playback of the combined multimedia and advertisement file means stopping or otherwise circumventing the advertisement to avoid playback of the advertisement. As used herein, the term “remove” in the context of the playback of the combined multimedia and advertisement file means modifying the file to avoid avoid playback of the advertisement. In this manner, multimedia files can be made available to users at no cost to the user, and sponsors can target advertising at specific demographic audiences based upon the content of the multimedia files.

As described above, the advertisements can comprise audio and/or audio/visual advertisements, depending on the type of multimedia file downloaded, and can be from about five seconds to about sixty seconds long, for example. The advertisements can be configured to play the first time the combined multimedia and advertisement file is played back by the user on the media player, every time the file is played back by the user, or any other suitable number of times (e.g., three times, five times, ten times, etc.). In some embodiments, the length of the advertisement, number of advertisements combined with the multimedia file, and the number of times the advertisement plays or displays can depend upon, for example, the popularity of the multimedia file (as measured by, e.g., the number of downloads), or the fee paid by the sponsor, etc. After the advertisement has been played or displayed a predetermined number of times, the advertisement can be disabled or removed from the combined multimedia and advertisement file. In alternative embodiments, the advertisement can be an image or icon that displays on the graphical user interface 302 of the media player while the combined multimedia and advertisement file is being played back.

In some embodiments, the media player 300 can be configured such that a user can play back the combined multimedia and advertisement file only on the device to which the file was downloaded until the advertisement has been played and/or displayed the specified number of times. In some embodiments, after the advertisement has played the specified number of times, the media player can allow the user to freely transfer the combined multimedia and advertisement file from one device to another (e.g., from a desktop PC to a portable multimedia player). A play counter can indicate to the user the number of times that an advertisement has played and/or how many more times the advertisement must play and/or display before the combined multimedia and advertisement file can be played back without the advertisement.

In some embodiments, the combined multimedia and advertisement files can also include bonus digital content such as album art, lyrics, bonus video clips, outtakes, bonus tracks, etc., some or all of which can be provided by sponsors. The media player can also include a feature whereby a user can elect to receive new multimedia content from particular content providers, artists, or performers (e.g., songs from a particular artist or record label, films starring a particular actor, etc.) from the multimedia provider service 326 as soon as the multimedia content is made available on the multimedia content server 332. In some embodiments, if the user has elected to download similar multimedia files with combined advertisements in the past, downloads of new multimedia files can automatically include combined advertisements. In this manner, a user can receive new multimedia content for free without the need to search for and purchase the multimedia file from the multimedia provider service, even if the user is unaware of the existence of the new multimedia file.

In some embodiments, sponsors can have access to information such as the number of users who have elected to receive new multimedia content from specific content providers or artists, along with other demographic information regarding those users such as age, gender, geographic location, etc. In this manner, sponsors can specifically tailor the content of advertisements to be included with downloads of multimedia files, particularly upcoming releases of new multimedia files.

The one or more advertisements can be combined with the multimedia file in any of various ways. In some embodiments, the one or more advertisements can be appended to the multimedia file to create a combined multimedia and advertisement file. In some embodiments, the advertisement appended to or otherwise associated with the combined multimedia and advertisement file can be updated and/or replaced such that a new advertisement can be played when the combined multimedia and advertisement file is next played back by the user instead of the advertisement originally combined with the multimedia file. In other embodiments, the combined multimedia and advertisement file can include a marker or tag that causes the media player to stream one or more advertisements directly from the multimedia provider service 326. In some embodiments, the replacement advertisement may come from the same sponsor as the original advertisement, or from a different sponsor.

In some embodiments, a user who downloads a combined multimedia and advertisement file for free can later elect to purchase the multimedia file to avoid future playback of the combined advertisement. In some embodiments, the user can be credited with a discount from the purchase price (i.e., the original fee to download the multimedia file from the multimedia provider service 326) corresponding to the number of times that the user has already listened to or viewed the advertisement. For example, if a user downloads a combined multimedia and advertisement file wherein the multimedia file has a purchase price of $1.00 and the combined advertisement is configured to play five times, and the user listens to the advertisement three times before electing to purchase the multimedia file, the price can be reduced by $0.20 for each time the advertisement was played. Thus, the user can be allowed to purchase the multimedia for $0.40 after listening to the advertisement of the combined multimedia and advertisement file three times out of the five times the advertisement was configured to play.

Alternatively, the media player can be configured to allow a user to “sample” a multimedia file by downloading it with an advertisement. If the user wishes to retain ownership of the downloaded copy, the user can continue to playback the combined multimedia and advertisement file until the advertisement has played a specified number of times. If the user does not wish to retain ownership of the combined multimedia and advertisement file, the user can notify the media service by, e.g., clicking on a “remove” button or icon on the media player (not shown). The media service can then remove the combined multimedia and advertisement file from the media player, disable playback of the file, etc. In this manner, a user can defray the cost of purchasing a multimedia file while being afforded the opportunity to decide whether they want to own a copy of a particular multimedia file.

In some embodiments, advertisement sponsors can maintain accounts with the multimedia provider service. The accounts can allow the advertisement sponsors to reach particular user demographics by focusing on, e.g., particular types and/or genres of multimedia (e.g., genres of music, movies, etc.), times of day when users are active online, users' location, etc. For example, sponsors can have the option to bid on or purchase outright options to combine the sponsor's advertisement with specific multimedia files, specific categories of multimedia files, producers of multimedia files, specific artists or performers featured in multimedia files, etc. In some embodiments, software incorporated into the media player 300 and the multimedia provider service 326 can track metrics such as the number of downloads initiated and/or downloads requests for a particular multimedia file, and make those metrics available to sponsors. Such information can then be used to set the fee charged to sponsors for combining advertisements with downloaded multimedia files.

In some embodiments, advertisements can include prizes and/or promotions, and feature the voice or likeness of artists or performers (e.g., musicians, actors, etc.) whose content is contained in the multimedia file. This can aid the sponsors in targeting a particular audience demographic with advertising content, and generate additional revenue streams for artists featured in such advertisements. In alternative embodiments, the media player can feature sponsor information such as advertisements on the graphical user interface 302 in multimedia format, for example, such as audio, video, and/or text.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope of these claims.

I claim:

1. One or more computer-readable media storing computer-executable instructions for causing a computer to perform a method of combining advertising content with multimedia content available for download on-demand by a user, the method comprising:
over a network,
receiving a request to download a multimedia file from a multimedia content server available through a multimedia provider service, the request originating from a media player;
combining the multimedia file with one or more advertisements provided by one or more sponsors to create a combined multimedia and advertisement file;
transmitting the combined multimedia and advertisement file to the media player;
saving the combined multimedia and advertisement file for later playback; and
playing the one or more advertisements when the combined multimedia and advertisement file is played back on the media player;
wherein the one or more advertisements are configured to play a predetermined number of times and then cease playing after the combined multimedia and advertisement file has been played back the predetermined number of times.

2. The method of claim 1, wherein combining the multimedia file with the one or more advertisements further comprises appending the one or more advertisements to the multimedia file.

3. The method of claim 2, wherein after the multimedia file has been played back the predetermined number of times, the one or more advertisements are removed from the combined multimedia and advertisement file.

4. The method of claim 2, wherein after the combined multimedia and advertisement file has been played back the predetermined number of times, playback of the one or more appended advertisements is disabled.

5. The method of claim 1, wherein:
combining the multimedia file with the one or more advertisements further comprises associating the multimedia file with one or more advertisements, the one or more advertisements being stored on an advertisement content server; and
playing the one or more advertisements further comprises streaming the one or more advertisements from the advertisement content server.

6. The method of claim 1, further comprising allowing a user to transfer the combined multimedia and advertisement file from one electronic device to another after the one or more advertisements have been played the predetermined number of times.

7. The method of claim 1, wherein:
the multimedia file contains multimedia content from a particular artist or performer; and
the one or more advertisements combined with the multimedia file contain advertising content featuring the artist or performer.

8. The method of claim 1, wherein the media player is configured to track the number of times that the one or more advertisements have been played.

9. The method of claim 8, wherein:
the media player is configured to allow a user to elect to purchase the downloaded media file; and
the user receives a discount corresponding to the number of times that the one or more advertisements were played on the media player.

10. A system for combining advertising content with multimedia content available for download by a user, comprising:
a media player configured to play multimedia files; and
a multimedia provider service in communication with the media player over a network, the media provider service including a multimedia content server having a database containing multimedia files and an advertising content server containing advertisements;
wherein the multimedia provider service is configured to receive a request from the media player to download a multimedia file, combine the requested multimedia file with one or more advertisements, and transmit the combined multimedia and advertisement file to the media player; and
wherein the one or more advertisements are configured to play a predetermined number of times when the combined multimedia and advertisement file is played back on the media player and then cease playing after the combined multimedia and advertisement file has been played back the predetermined number of times.

11. The system of claim 10, wherein the one or more advertisements are appended to the multimedia file to create the combined multimedia and advertisement file.

12. The system of claim 11, wherein after the multimedia file has been played back the predetermined number of times, the one or more advertisements are removed from the combined multimedia and advertisement file.

13. The method of claim 11, wherein after the combined multimedia and advertisement file has been played back the predetermined number of times, playback of the one or more appended advertisements is disabled.

14. The system of claim 10, wherein:
The requested multimedia file is associated with one or more advertisements stored on the advertisement content server; and
the one or more advertisements are streamed from the advertisement content server when the combined multimedia and advertisement file is played back on the media player.

15. One or more computer-readable media storing computer-executable instructions for causing the computer to perform a method of combining advertising content with media content made available for download on-demand by a user, the method comprising:
receiving a first media file from a first party containing non-advertising content;
receiving a second media file from a second party containing advertising content;
receiving a request to identify media content being concurrently experienced by a user, the request containing data associated with the media content;
identifying the media content as the first media file based at least in part on the data provided in the request;
combining the first media file with the second media file to create a third media file; and
transmitting the third media file to at least one device designated by the user where the third media file is saved for later playback.

16. The method of claim 15, further comprising collecting a fee from the second party when the first media file is combined with the second media file to create the third media file.

17. The method of claim 15, further comprising collecting a fee from the second party when the third media file is transmitted to the at least one device designated by the user.

18. The method of claim 15, wherein the data contained in the request to identify media content is a song title and artist name.

19. The method of claim 15, wherein the data contained in the request to identify media content is data obtained by sampling the media being concurrently experienced by the user.

20. The method of claim 15, further comprising displaying to the user an advertising message concurrently with transmission of the third media file to the at least one designated device.

21. The method of claim 15, wherein the designated device is at least one of a mobile phone, a tablet, a computer, a portable music player, and an automobile stereo.

22. The method of claim 15, wherein the advertising content is configured to play a predetermined number of times when the third media file is played back and cease playing after the third media file has been played back the predetermined number of times.
